(19) United States
(12) Patent Application Publication
(10) Pub. No.: US 2014/0023324 A1
(43) Pub. Date: Jan. 23, 2014

(54) OPTICAL CONNECTION DEVICE FOR PLASTIC OPTICAL FIBRE

(71) Applicant: Eduardo Ortego Martinez, Madrid (ES)

(72) Inventor: Eduardo Ortego Martinez, Madrid (ES)

(73) Assignee: TELEFONICA, S.A., Madrid (ES)

(21) Appl. No.: 13/983,950

(22) PCT Filed: Jan. 27, 2012
(86) PCT No.: PCT/EP12/51312

§ 371 Date: Oct. 2, 2013

(30) Foreign Application Priority Data
Feb. 7, 2011 (ES) P201130161

(51) Int. Cl. G02B 6/36

(52) U.S. Cl. CPC G02B 6/3616
USPC 385/77

(57) ABSTRACT

The optical connection device comprises a housing body (20) having a transceiver cavity (21) to receive an optical transceiver and an approaching channel formed about a longitudinal axis (15) to receive a plastic optical fibre (10) having a termination (11) adjacent to and aligned with said optical transceiver, a deformable clamp arranged around said plastic optical fibre (10), and a movable fixer element (40) configured to deform said deformable clamp to grip the plastic optical fibre (10) when said fixer element (40) is moved in a fixing direction with respect to said housing body (20). The fixer element (40) is moved in said fixing direction by a fixer spring member (70) and a releaser element (50) is arranged to move the fixer element (40) in an opposite releasing direction for releasing the deformable clamp when said releaser element (50) is manually depressed.

### FIELD OF THE ART

The present invention generally relates to an optical connection device for plastic optical fibre which provides a constant retention pressure on a plastic optical fibre towards an optical transceiver to improve the contact therebetween and which comprises a plurality of components housed in a housing body without protruding from de housing body.

### PRIOR STATE OF THE ART

The use of plastic optical fibre (POF) is spreading and growing, but this is not a mature technology and there is a lack of standardization bodies. This technology is able to work with many different connectors, but this wide range of possibilities creates a problem with the compatibility of the devices.

Another way of working with this technology is the so called “connectorless”, where the cables used to connect the plastic optical fibre based devices do not use any kind of connector. The only connector device is located in the equipments.

Nowadays, there are several devices that use the connectorless approach. These devices have a fixed channel to align and fix the plastic optical fibre in the correct position. The channel is closed over the fibre to clamp it by a pressure element that is adjusted by hand.

The most extended solution is the so called “Optolock” where a clamp on the plastic optical fibre is done by manually pushing a fixer part on a clamp arranged around the plastic optical fibre. This “Optolock” device is described in U.S. Pat. No. 7,597,485.

Another way of closing the channel over the fibre is by means of a threaded piece. This is used in Avago Technologies devices as can be seen in the connectorless family small form-factor pluggable (SFH) series shown in

http://www.ebv.com/fileadmin/products/Press Print/Brochures/Product Brochures/Avago Industrial Fiber Optics.pdf.

The devices mentioned above have mainly two disadvantages:

A first problem is that the clamping force on the fibre depends on the manual pressure exerted upon the connection.
A second problem present in both previous solutions is that some components of the connectors protrude from the housing where the components are installed, so that there is a risk to break or deform the components or the housing.

### DISCLOSURE OF THE INVENTION

The present invention contributes to mitigate the above and other disadvantages by providing an optical connection device for plastic optical fibre comprising a housing body having a transceiver cavity to receive an optical transceiver and an approaching channel formed about a longitudinal axis to receive a plastic optical fibre having a termination adjacent to and aligned with said optical transceiver, a deformable clamp arranged around said plastic optical fibre, and a movable fixer element configured to deform said deformable clamp to grip the plastic optical fibre when said fixer element is moved in a fixing direction with respect to said housing body. The fixer element is moved in said fixing direction by a fixer spring member and a releaser element is arranged to move the fixer element in an opposite releasing direction for releasing the deformable clamp when said releaser element is manually depressed.

In one embodiment, said releaser element is movable with respect to the housing body between an idle position and a releasing position, and a releaser spring member is arranged to urge the releaser element to said idle position, and the deformable clamp is a clamp member that moves with respect to the housing body and over the plastic optical fibre. When the releaser element is depressed the fixer element is moved in the releasing direction and the clamp member opens so that the plastic optical fibre can be inserted thereinto. When the releaser element is released the fixer element is moved in the fixing direction by the fixer spring member and the force exerted by the fixer spring member on the fixer element is transmitted to the clamp member to deform it and grip the plastic optical fibre.

The force exerted by the fixer spring member on the fixer element and the clamp member also keeps a constant pressure on the optical fibre 10 towards the optical transceiver to improve the contact therebetween.

Opening and closing the device is performed by a slight pressure on the releaser element, and as the closing axial force is exerted on the fixer element by the fixer spring member, the closing axial force is virtually constant and dos not depend on a force manually applied by a user.

The optical connection device of the present invention is mainly focused on being used with plastic optical fibre cabling having an outer diameter of 1.5 or 2.2 mm, and their measures can be adapted to it in an appropriate way. However the optical connection device can be alternatively adapted to plastic optical fibre cabling having any outer diameter.

The optical connection device of the present invention is used to fix the plastic optical fibre to the transceivers in mutual alignment and without lateral displacement.

The transceiver cavity of the housing body can be adapted to any optical transceiver, and the optical connection device can be commercially supplied with the optical transceiver included or not.

The housing body of the optical connection device houses the rest of the components of the device and optionally the optical transceiver without any of them protruding from the housing body. This avoids the risk of breaking or damaging the components or optical transceiver.

The main advantages of the optical connection device of the present invention are as follows:
The optical connection device does not protrude from the container equipment where the optical connection device is installed. The optical connection devices of the prior art protrude from the equipments because the closing/opening mechanism needs to be performed by hand, in this case opening and closing is done by pushing a button that it does not need to protrude from the container equipment.
The opening and closing mechanism can be driven directly or through a button/switch located on the outside of the container equipment.
Clamp pressure does not depend on the manual force with which the device is manipulated.
Fibre is constantly pressed against the transceiver to avoid losses due to bad contact.

### BRIEF DESCRIPTION OF THE DRAWINGS

The previous and other advantages and features will be more fully understood from the following detailed description of one exemplary embodiment, with reference to the attached illustrative and non-limiting drawings, in which:

FIG. 1 is a cross-sectional view of a constant retention pressure non-protruding optical connection device for optical fibre according to an exemplary embodiment of the present invention, including a plastic optical fibre termination;

FIG. 2A is a front view of a housing body which makes part of the connection device assembly of FIG. 1;

FIG. 2B is a cross-sectional view taken along the line A-A of FIG. 2A;

FIG. 2C is a cross-sectional view taken along the line B-B of FIG. 2A;

FIG. 2D is a cross-sectional view taken along the line C-C of FIG. 2A;

FIG. 2E is a top plan view of the housing body of FIG. 2A;

FIG. 3A is a side view of a clamp member which makes part of the connection device assembly of FIG. 1;

FIG. 3B is a front view of the clamp member of FIG. 3A;

FIG. 3C is a cross-sectional view taken along the line A-A of FIG. 3B;

FIG. 4A is a front view of a fixer element which makes part of the connection device assembly of FIG. 1;

FIG. 4B is a cross-sectional view taken along the line A-A of FIG. 4A;

FIG. 4C is a top view of the fixer element of FIG. 4A;

FIG. 5A is a front view of a releaser element which makes part of the connection device assembly of FIG. 1;

FIG. 5B is a side view of the releaser element of FIG. 5A;

FIG. 5C is a bottom plan view of the releaser element of FIG. 5A;

FIG. 6A is a side view of a guide member which makes part of the connection device assembly of FIG. 1;

FIG. 6B is a side view of the guide member of FIG. 6A;

FIG. 7A is a plan view of a first elastic strip which makes part of the connection device assembly of FIG. 1;

FIG. 7B is a side view of the first elastic strip of FIG. 7A in a forced position;

FIG. 8A is a plan view of a second elastic strip which makes part of the connection device assembly of FIG. 1;

FIG. 8B is a side view of the second elastic strip of FIG. 8A in a forced position;

FIG. 9A front view of a first clip which makes part of the connection device assembly of FIG. 1;

FIG. 9B is a side view of the first clip of FIG. 9A;

FIG. 10A front view of a second dip which makes part of the connection device assembly of FIG. 1; and

FIG. 10B is a side view of the second clip of FIG. 10A.

### DETAILED DESCRIPTION OF AN EXEMPLARY EMBODIMENT

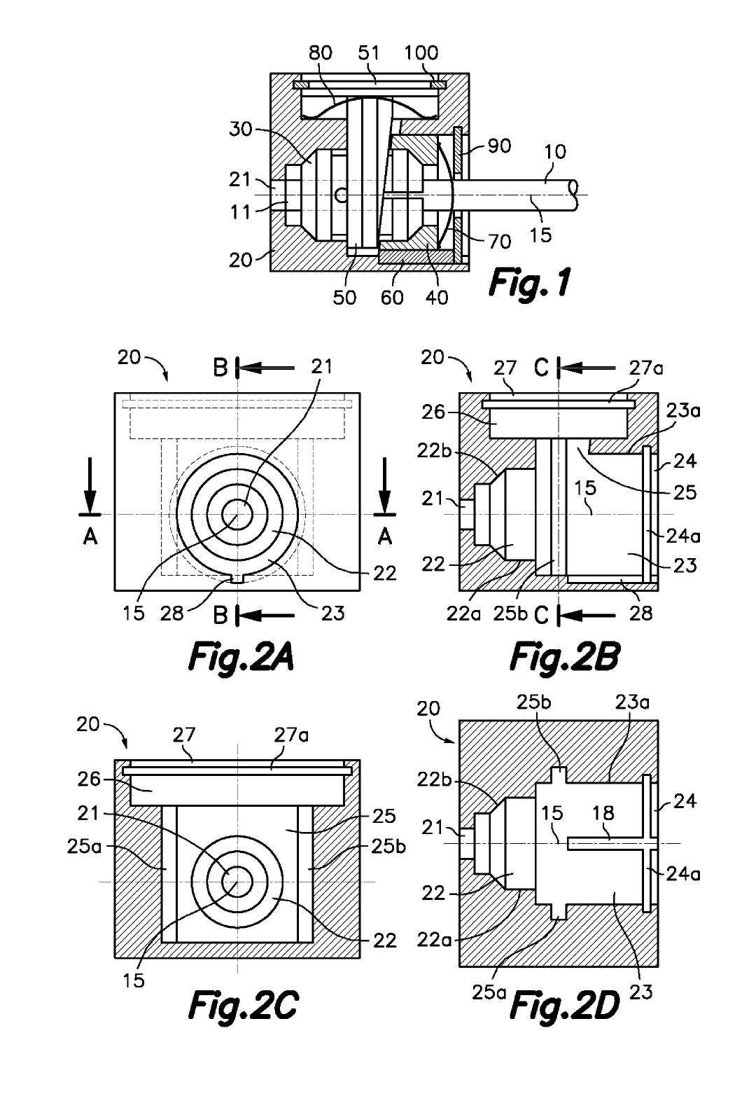

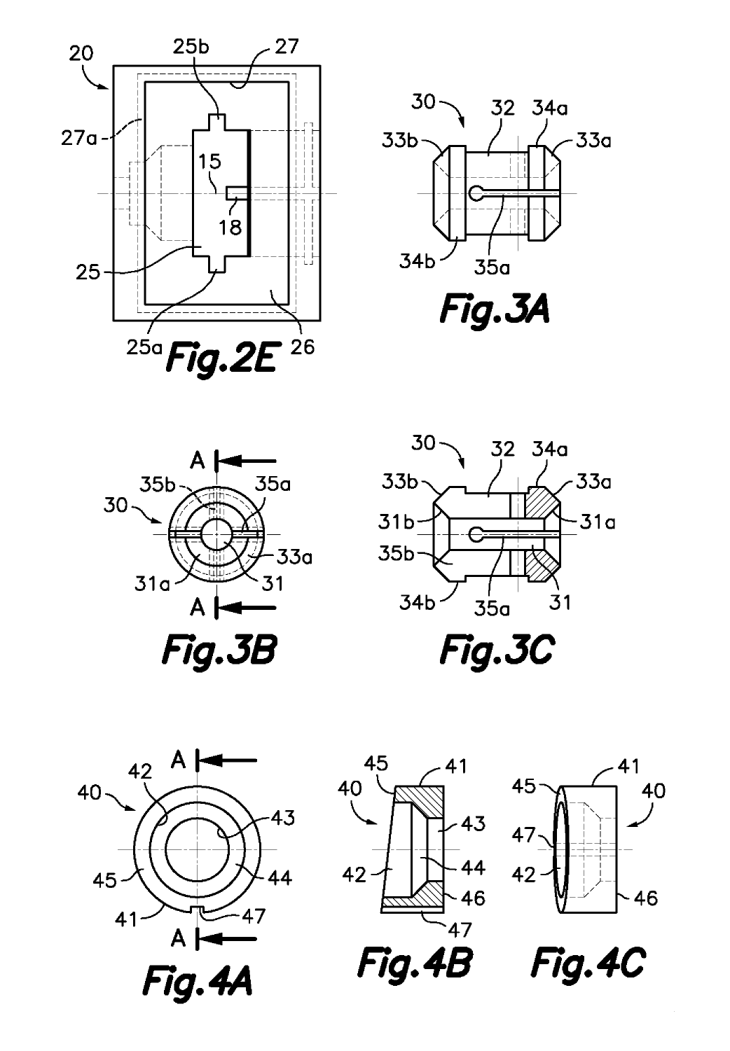

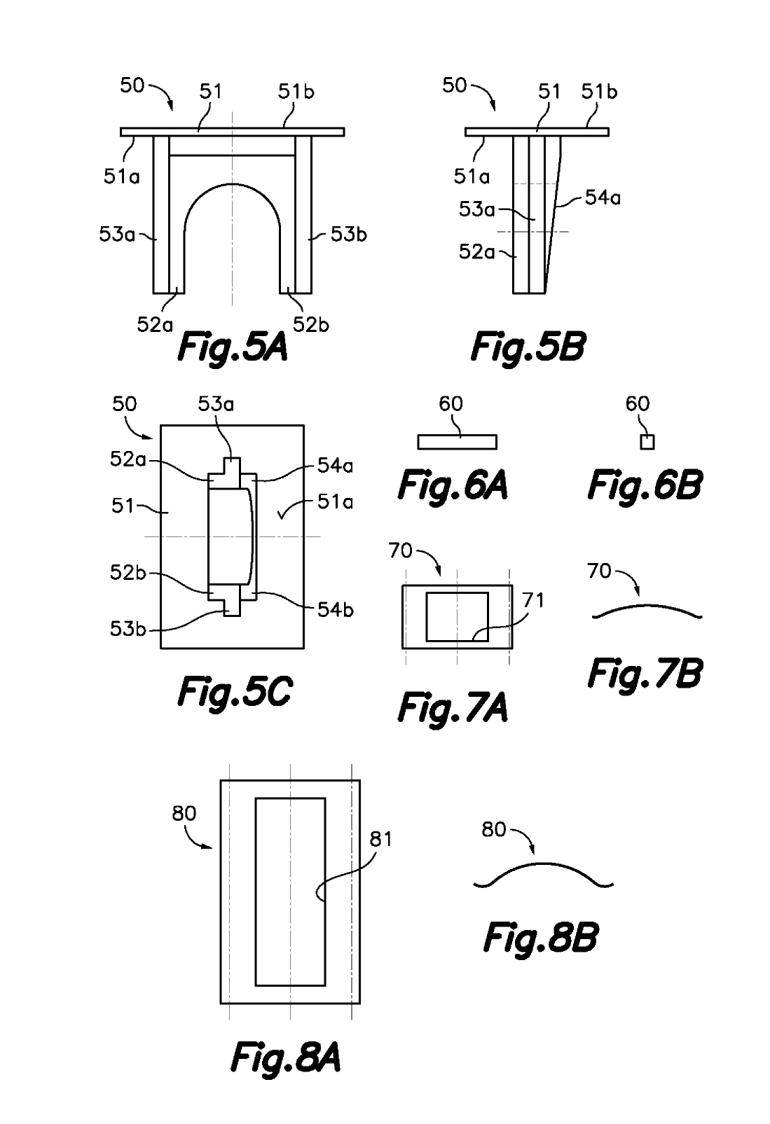

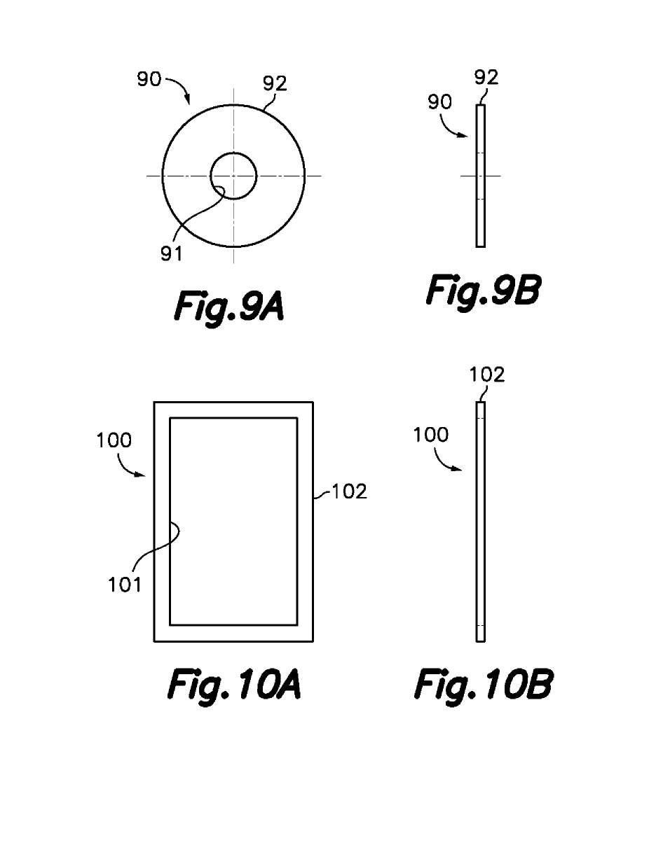

Referring first to FIG. 1, there is shown a complete cross-sectional view of an optical connection device according to an exemplary embodiment of the present invention, which comprises a housing body 20 (shown in detail in FIGS. 2A-2E), a clamp member 30 (shown in detail in FIGS. 3A-3C), a fixer element 40 (shown in detail in FIGS. 4A-4C), a releaser element 50 (shown in detail in FIGS. 5A-5C), a guide member 60 (shown in detail in FIGS. 6A-6B), fixer and releaser spring members 70, 80 (shown in detail in FIGS. 7A-7B and 8A-8B, respectively) and fixer and releaser clips 90, 100 (shown in detail in FIGS. 9A-9B and 10A-10B, respectively).

The clamp member 30, the fixer element 40, the releaser element 50, the guide member 60, the fixer and releaser spring members 70, 80 and the fixer and releaser clips 90, 100, as well as transmission/reception optical elements (transceivers), are located inside the housing body 20 so that none of them protrudes from the housing body 20.

The mentioned housing body 20 (FIGS. 2A-2E) comprises an approaching channel having a generally revolution shape about a longitudinal axis 15. Said approaching channel is open at one axial end through a transceiver cavity 21 dimensioned to receive an optical transceiver (not shown) and at the opposite axial end through an end opening 24. The approaching channel defines a clamp cavity 22 adjacent the transceiver cavity 21 and a fixer cavity 23 adjacent the end opening 24. The clamp cavity 22 is wider than the transceiver cavity 21, the fixer cavity 23 is wider than clamp cavity 22, and the end opening 24 is as wider as the fixer cavity 23. The transceiver cavity 21, the clamp cavity 22, the fixer cavity 23 and the end opening 24 have respective cylindrical sections coaxial with the longitudinal axis 15.

A releaser passage 25 is transversally formed in the body housing 20 in intersection with the approaching channel. Said releaser passage 25 communicates one end of the fixer cavity 23 adjacent the clamp cavity 22 with a releaser cavity 26 having a top opening 27. The releaser cavity 26 and the top opening 27 have an equal rectangular

Guiding slots 25a, 25b are formed along side edges of the releaser passage 25 in perpendicular directions with respect to the longitudinal axis 15. A longitudinal slot 28 parallel to the longitudinal axis 15 is formed in a lowermost region of the fixer cavity 23 opposed to the top opening 27. Said longitudinal slot 28 extends from the end opening 24 to the releaser passage 25.

The mentioned clamp member 30 (FIGS. 3A-3C) comprises a body having a generally revolution shape about a longitudinal axis with an axial bore 31 extending from end to end thereof. Said axial bore 31 has tapered ends 31a, 31b. The outer surface of the clamp member 30 defines a cylindrical middle section 32, first and second cylindrical guide sections 33a, 33b located at both sides of the cylindrical middle section 32, said first and second cylindrical guide sections 33a, 33b having a larger diameter than the cylindrical middle section 32, and first and second end conical sections 34a, 34b located at both sides of the first and second cylindrical guide sections 33a, 33b. The body of the clamp member 30 includes first and second slits 35a, 35b extending in mutually perpendicular axial planes from opposed ends thereof. Each of said first and second slits 35a, 35b splits the corresponding first and second end conical section 34a, 34b, first and second cylindrical guide section 33a, 33b, and part of the cylindrical middle section 32.

The mentioned fixer element 40 (FIGS. 4A-4C) comprises a body having a cylindrical outer surface 41 about a longitudinal axis and an axial bore extending from end to end thereof. Said axial bore comprises a cylindrical guide portion 42 adjacent to an inner end, a cylindrical opening 43 adjacent to an outer end, said cylindrical opening 43 having a minor diameter than the cylindrical guide portion 42, and a female conical section 44 connecting the cylindrical guide portion 42 and the cylindrical opening 43. The body of the fixer element 40 has an inner inclined surface 45 defining a plane inclined with respect to the longitudinal axis and an outer surface 46 defining a plane perpendicular with respect to the longitudinal axis. A longitudinal slot 47 is formed in the lowermost region of the cylindrical outer surface 41 where the axial dimension thereof reaches a maximum.

The mentioned releaser element 50 (FIGS. 5A-5C) comprises a push head 51 having an inner surface 51a and an outer surface 51b, and a pair of parallel and spaced apart releaser legs 52a, 52b extending from the inner surface 51a of the push head 51. Guiding ribs 53a, 53b are formed along outer side edges of the releaser legs 52a, 52b extending from the push head 51 to the free end of the releaser legs 52a, 52b. The guiding ribs 53a, 53b are perpendicular to and equidistant from a longitudinal axis. Each of the releaser legs 52a, 52b has an outer inclined surface 54a, 54b defining a plane inclined with respect to the longitudinal axis.

When mutually assembled as shown in FIG. 1, the second cylindrical guide section 33b of the clamp member 30 fits in a corresponding cylindrical guide portion 22a formed in the clamp cavity 22 of the housing body 20 so that the clamp member 30 can axially move therein, and the second end conical section 34b of the clamp member 30 abuts on a corresponding female conical section 22b formed in the housing body 20 at one end of the clamp cavity 22 adjacent the transceiver cavity 21. The axial bore 31 of the clamp member 30 is aligned with the longitudinal axis 15 of the housing body by virtue of a centring action carried out by the respective cylindrical guide section 33a and cylindrical guide portion 22a.

Preferably, the clamp member 30 is symmetrical with respect to a median plane thereof perpendicular to its longitudinal axis so that the clamp member 30 can be inserted in any of the two axial positions. The recessed cylindrical middle section 32 of the clamp member 30 is not essential, and the function thereof is to decrease the surface friction between the clamp member 30 and the housing body 20.

The fixer element 40 is inserted in the fixer cavity 23 of the housing body 20 through the end opening 24. The cylindrical outer surface 41 of the fixer element 40 fits in a cylindrical inner surface 23a of the fixer cavity 23 so that the fixer element 40 can axially move therein in opposed fixing and realising directions. The axial bore of the fixer element 30 is aligned with the longitudinal axis 15 of the housing body by virtue of a centring action carried out by the respective cylindrical outer surface section 41 and cylindrical inner surface 23a. When the fixer element 40 is located within the fixer cavity 23 of the housing body 20, the first cylindrical guide section 33a of the clamp member 30 fits in the cylindrical guide portion 42 of the fixer element 40 so that the clamp member 30 can axially move therein, and the first end conical section 34a of the clamp member 30 abuts on the female conical section 44 of the fixer element 40.

The aforementioned guide member 60 (FIGS. 6A and 6B) comprises an elongated body having a generally rectangular cross section. The guide member 60 has a lower region inserted in the longitudinal slot 28 of the housing body 20 and an upper region inserted in the longitudinal slot 47 of the fixer element 40 in order to keep the fixer element 40 in an angular position in which the inclined surface 45 of the fixer element 40 is at a required position with respect to the releaser passage 25 of the housing body 20.

The aforementioned fixer spring member 70 (FIGS. 7A-7B) comprises an arched rectangular element made of elastic sheet metal having a hole 71 formed therein, and the aforementioned fixer clip 90 (FIGS. 9A-9B) comprises a ring element having a central hole 91 and an outer edge 92. The fixer spring member 70 is inserted into the fixer cavity 23 of the housing body 20 through the end opening 24 and is retained therein by the fixer clip 90, the outer edge 92 of which is inserted in a perimetric slot 24a formed in the housing body 20 near the end opening 24, so that the fixer spring member 70 is compressed between the fixer clip 90 and the fixer element 40 and axially moves the fixer element 40 in said fixing direction.

The elastic axial force exerted by the fixer spring member 70 on the fixer element 40 is converted by virtue of the female conical section 22b of the housing body 20 and the female conical section 44 of the fixer element 40 abutting on the first and second end conical sections 34a, 34b of the clamp member, respectively, in radial forces that in combination with the first and second slits 35a, 35b cause a deformation in the clamp member 30 that tend to narrow the axial bore 31 of the clamp member 30.

The releaser element 50 is inserted into the releaser passage 25 and into the releaser cavity 26 of the body housing 20 through the top opening 27 by sliding the guiding ribs 53a, 53b formed on the releaser legs 52a, 52b of the releaser element 50 along the guiding slots 25a, 25b formed in the housing body 20 so that the releaser element 50 can move with respect to the housing body 20 between an idle position and a releasing position. The releaser legs 52a, 52b of the releaser element 50 are located at both sides of the cylindrical middle section 32 of the clamp member 30 and the outer inclined surface 54a, 54b of the releaser element 50 is facing and near to the conjugated inner inclined surface 45 of the fixer element 40.

The aforementioned releaser clip 100 (FIGS. 10A-10B) comprises a rectangular ring element having an aperture 101 rectangular in shape and an outer edge 102 which is inserted in a perimetric slot 27a formed in the releaser cavity 26 of the housing body 20 near the top opening 27. The releaser clip 100 interferes with the upper surface 51b of the push head 51 of the releaser element 50 so that the releaser element 50 is retained in the releaser cavity 26 by the releaser clip 100, and the upper surface 51b of the push head 51 of the releaser element 50 is exposed through the aperture 101 of the releaser clip 100. The releaser element 50 can be pushed directly or by means of some external button.

The aforementioned releaser spring member 80 (FIGS. 8A-8B) comprises an arched rectangular element made of elastic sheet metal having a rectangular hole 81 formed therein. The releaser spring member 80 is located within the releaser cavity 26 with the releaser legs 52a, 52b of the releaser element 50 inserted through the rectangular hole 81 of the releaser spring member 80. The releaser spring member 80 is compressed between a bottom surface of the releaser cavity 26 of the housing body 20 and the inner surface 51a of the push head 51 of the releaser element 50.

The transverse elastic force exerted by the releaser spring member 80 urges the releaser element 50 to said idle position against the releaser clip 100. When the push head 51 of the releaser element 50 is manually pushed inwards to said releasing position by applying a transverse force thereon through the top opening 27 of the releaser cavity 26 and the aperture 101 of the releaser clip 100, the releaser element 50 is moved inwards against the elastic transverse force exerted by the releaser spring member 80, and the transverse force applied on the push head 51 is converted by virtue of the contact between the outer inclined surfaces 54a, 54b of the releaser element 50 and the conjugated inner inclined surface 45 of the fixer element 40 in an axial force that axially moves the fixer element 40 in said releasing direction against the axial force exerted by the fixer spring member 70.

This axial movement in the realising direction of the fixer element 40 releases the radial forces exerted by it on the clamp member 30 so that the axial bore 31 of the clamp member 30 can recover its original shape. When the transverse force applied on the push head 51 of the release element 50 is ceased, the releaser spring member 80 moves the releaser element 50 again to the idle position and the fixer spring member 70 pushes again on the fixer element 40 to apply radial forces on the clamp member 30.

In use, a plastic optical fibre 10 is inserted into the axial bore 32 of the clamp member 30 and into the axial bore of the fixer element 40, which are housed in the housing body 20, through the end opening 24 of the housing body 20, the central hole 91 of the fixer clip 90 and the hole 71 of the fixer spring member 70 until a termination 11 of the plastic optical fibre 10 is adjacent to the optical transceiver (not shown) housed in the transceiver cavity 21. The axial bore 32 of the clamp member 30 is aligned with the longitudinal axis 15 and dimensioned to fit the outer surface of the plastic optical fibre 10, such that the plastic optical fibre 10 is kept in alignment with the longitudinal axis 15 by the clamp member 30.

For inserting the plastic optical fibre 10 is necessary previously to depress the push head 51 of the releaser element 50 in order to release the radial forces acting on the clamp member 30. The tapered ends 31a, 31b of the axial bore 31 of the clamp member 30 facilitate insertion of the plastic optical fibre 10. Once the plastic optical fibre 10 is inserted to the working position, the push head 51 of the releaser element 50 is released such that the radial forces act again on the clamp member 30 to deform it so as to grip on the plastic optical fibre 10 and keep it in the working position. To open the clamp member 30 and extract the plastic optical fibre 10 it is enough to depress again the push head 51 of the release element 50.

As the closing axial force is exerted on the fixer element 40 by the fixer spring member 70, the closing axial force is virtually constant and dos not depend on a force manually applied by a user. The plastic optical fibre 10 is kept perfectly aligned and without lateral displacement with respect to the optical transceiver, and the clamp member 30 and the fixer element 40 provide a constant pressure on the optical fibre 10 towards the optical transceiver to improve the contact therebetween. Any of the components 30-100 which are housed in the housing body 20 protrudes from the housing body 20, such that there is no risk of breaking or damaging them.

Alternatively, the releaser element can be arranged to move in a direction parallel or inclined with respect to the longitudinal axis 15 so the opening force can be applied from the front end of the housing body (20) or from other parts thereof. Alternatively, the fixer and releaser spring members 70, 80 made of elastic sheet metal can be substituted by helical springs or other similar spring or resilient elements.

The optical connection device according to the present invention is mainly focussed to be used with plastic optical fibre cabling having an outer diameter of 1.5 or 2.2 mm. But the optical connection device can be adapted to plastic optical fibre cabling having any outer diameter by appropriately dimensioning their components. The transceiver cavity can also be adapted to the dimensions of any kind of optical transceiver.

The most cost effective material to manufacture the main components of the optical connector device of the present invention, such as the housing body 20, the clamp member 30, the fixer element 40 and the releaser element 50 is the moulded plastics construction. But they can alternatively be epoxy or metallic.

Optionally, an electro-magnetic interference (EMI) shield can be put around the housing body 20 of the optical connector device, and the optical connector device can be secured by welding or bolts to the container equipment where the optical connection device is installed.

Although the optical connection device of the present invention is here described and shown as a simplex optical fibre connector, the optical connection device of the present invention can be used with duplex optical fibre by duplicating the elements and components thereof.

The optical connection device of the present invention can be preferably commercially supplied with the optical transceiver included, and with the input openings for the plastic optical fibre closed by a cap or a closing curtain.

Variation and modifications on the exemplary embodiment shown and described will readily occur to one skilled in the art without departing from the scope of the present invention as defined in the appended claims.

1. An optical connection device for plastic optical fibre comprising a housing body (20) having a transceiver cavity (21) to receive an optical transceiver and an approaching channel formed about a longitudinal axis (15) to receive a plastic optical fibre (10) having a termination (11) adjacent to and aligned with said optical transceiver, a deformable clamp arranged around said plastic optical fibre (10), and a movable fixer element (40) configured to deform said deformable clamp to grip the plastic optical fibre (10) when said fixer element (40) is moved in a fixing direction with respect to said housing body (20), characterised in that the fixer element (40) is moved in said fixing direction by a fixer spring member (70) and a releaser element (50) is arranged to move the fixer element (40) in a releasing direction opposite to the fixing direction, for releasing the deformable clamp when said releaser element (50) is manually depressed.

2. The optical connection device according to claim 1, characterised in that said releaser element (50) is movable with respect to the housing body (20) between an idle position and a releasing position, and a releaser spring member (80) is arranged to urge the releaser element (50) to said idle position.

3. The optical connection device according to claim 2, characterised in that the deformable clamp comprises a clamp member (30) arranged in said approaching channel to move along said longitudinal axis (15), the fixer element (40) is also arranged in the approaching channel to move along the longitudinal axis (15), and said releaser element (50) is arranged in a releaser passage (25) formed in the body housing (10) to move transversally to the longitudinal axis (15).

4. The optical connection device according to claim 3, characterised in that the releaser element (50) comprises an inclined surface (54a, 54b) that makes contact with a conjugated inclined surface (45) formed on the fixer element (40) to move the fixer element (40) to its releasing position against a force exerted by said fixer spring member (70) when the releaser element (50) is moved from the idle position to the releasing position against a force exerted by the said releaser spring member (80).

5. The optical connection device according to claim 3, characterised in that said clamp member (30) comprises a first end conical section (33a) which abuts on a corresponding female conical section (44) formed in the fixer element (40) to convert an axial force exerted by said fixer spring member (70) on the fixer element (40) in radial forces applied on the clamp member (30) to deform the clamp member (30).

6. The optical connection device according to claim 5, characterised in that the clamp member (30) comprises a second end conical section (33b) opposite said first end conical member (33a), and said second end conical section (33b) abuts on a corresponding female conical section (22b) formed in the housing body (20) to convert said axial force exerted by said fixer spring member (70) on the fixer element (40) in radial forces applied on the clamp member (30) to deform the clamp member (30).

7. The optical connection device according to claim 6, characterised in that the clamp member (30) includes first and second slits (35a, 35b) extending from opposed ends thereof, said first and second slits (35a, 35b) splitting the corresponding first and second end conical sections (33a, 33b).

8. The optical connection device according to claim 4, characterised in that the releaser element (50) has a push head (41) housed in a releaser cavity (26) formed in the housing body (20) and retained therein by a releaser clip (100) attached to the housing body (20), said push head (41) being accessible through a top opening (27) of said releaser cavity (26) and through an aperture (101) of said releaser clip (100).

9. The optical connection device according to claim 8, characterised in that the releaser spring member (80) is compressed between a surface of the releaser cavity (26) of the housing body (20) and a surface of the push head (51) of the releaser element (50).

10. The optical connection device according to claim 3, characterised in that the fixer spring member (70) is compressed between a fixer clip (90) attached to the housing body (20) and the fixer element (40), and said fixer clip (90) and the fixer spring member (70) have respective holes (91, 71) through which the plastic optical fibre (10) can be inserted.

11. The optical connection device according to claim 3, characterised in that the fixer element (40) has a cylindrical outer surface (41) that fits in a cylindrical inner surface (23a) formed in the approaching channel of the housing body (20) so that the fixer element (40) can axially move in the housing body (20) in said opposite fixing and realising directions.

12. The optical connection device according to claim 11, characterised in that a guide member (60) is arranged to keep the fixer element (40) in an angular position with respect to the housing body (20) in which said inclined surface (45) of the fixer element (40) is at a required position with respect to said releaser passage (25) of the housing body (20) while permitting the axial movements of the fixer element (40) in said opposite fixing and realising directions.

13. The optical connection device according to claim 3, characterised in that the clamp member (30) comprises a first cylindrical guide section (34a) that fits in a cylindrical guide portion (42) of the fixer element (40) so that the clamp member (30) can axially move in the fixer element (40) and a second cylindrical guide section (34b) that fits in a cylindrical guide portion (22a) formed in the approaching channel of the housing body (20) so that the clamp member (30) can axially move in the housing body (20).

14. The optical connection device according to claim 2, characterised in that the clamp member (30), the fixer element (40), the releaser element (50), the guide member (60), the fixer and releaser spring members (70, 80) and the fixer and releaser clips (90, 100) are located within the housing body (20) so that none of them protrudes from the housing body (20).

15. The optical connection device according to claim 1, characterised in that said optical transceiver is included in said transceiver cavity (21) without protruding from the housing body (20).

16. The optical connection device according to claim 3, characterised in that the clamp member (30), the fixer element (40), the releaser element (50), the guide member (60), the fixer and releaser spring members (70, 80) and the fixer and releaser clips (90, 100) are located within the housing body (20) so that none of them protrudes from the housing body (20).

17. The optical connection device according to claim 8, characterised in that the clamp member (30), the fixer element (40), the releaser element (50), the guide member (60), the fixer and releaser spring members (70, 80) and the fixer and releaser clips (90, 100) are located within the housing body (20) so that none of them protrudes from the housing body (20).

18. The optical connection device according to claim 10, characterised in that the clamp member (30), the fixer element (40), the releaser element (50), the guide member (60), the fixer and releaser spring members (70, 80) and the fixer and releaser clips (90, 100) are located within the housing body (20) so that none of them protrudes from the housing body (20).

19. The optical connection device according to claim 12, characterised in that the clamp member (30), the fixer element (40), the releaser element (50), the guide member (60), the fixer and releaser spring members (70, 80) and the fixer and releaser clips (90, 100) are located within the housing body (20) so that none of them protrudes from the housing body (20).
